(19) United States
(12) Patent Application Publication
(10) Pub. No.: US 2013/0300873 A1
(43) Pub. Date: Nov. 14, 2013

(54) METHOD FOR MULTICHANNEL VIDEO SURVEILLANCE OF TRAFFIC INTERCHANGES

(71) Applicant: Pavel Anatolievich Klopov, Tyumen (RU)

(72) Inventor: Pavel Anatolievich Klopov, Tyumen (RU)

(21) Appl. No.: 13/979,926

(22) PCT Filed: Dec. 5, 2011
(86) PCT No.: PCT/RU2011/000959

§ 371 Date: Jul. 31, 2013

(30) Foreign Application Priority Data
Jan. 17, 2011 (RU) 2011101549

(51) Int. Cl. H04N 7/18

(52) U.S. Cl. CPC H04N 7/181
USPC 348/149

(57) ABSTRACT

A method for multichannel video monitoring of traffic interchanges relating to methods for multichannel video monitoring of congestion at traffic interchanges. To broaden the functionality by providing picture transmission in real time from several video cameras spread at different distances and displaying the picture on monitors, video cameras are placed at traffic interchanges, and the information received from the video cameras is transmitted over a data transmission system bus to the central reception console where the information received from the video cameras is processed and fed to a broadcasting studio equipment room where the information is formed, for instance, by multiplexing and displayed on the end user's screen, wherein any known system for presenting processed information to the end user is used, for instance, cable TV channels by means of which the filling with pictures received from video cameras placed at traffic interchanges is performed in real time.

### CROSS-REFERENCE TO RELATED APPLICATION

This present application claims the benefit of PCT Application Number PCT/RU2011/000959 filed Dec. 5, 2011 and published on Jul. 26, 2012. The earliest priority filing date claimed is Jan. 17, 2011.

### FEDERALLY SPONSORED RESEARCH

Not Applicable

### SEQUENCE LISTING OR PROGRAM

Not Applicable

### BACKGROUND

The proposed invention, “The method for multichannel video monitoring of traffic interchanges”, relates to methods for multichannel video monitoring of objects and can be used, in particular, for around-the-clock monitoring of the state of traffic load of interchanges at bridges, intersections and certain areas of streets.

Known is the method for TV, video and audio monitoring by means of a system that can be used for providing security of premises, vehicles and other objects. The method provides adaptation (synchronization of switching and methods for displaying) of devices responsible for receiving, managing and processing information from TV, video and audio monitoring systems with standard consumer recording and playback systems. The embodiment of the interface device makes it possible to use the TV, video and audio monitoring system as a consumer monitoring and security system. The TV signal from each monitoring camera is received by an interface device which synchronizes the cameras switching, displaying (recording) and picture selection with the reproducing (TV) or displaying (VCR) system. The selection unit provides synchronization of the selected channels using a control signal. The control unit provides synchronized switching of the cameras and displaying (recording) using a control signal. The method makes it possible to use consumer TV and video equipment in the monitoring system (Patent RU No. 2129304, published in 1999).

The drawback of the known method is its narrow functionality. The drawback is due to the fact that the known method does not provide simultaneous picture transmission from several video cameras in real time over a single multichannel system bus to the conversion point and displaying them on one or several monitors.

Also known is the method for video monitoring realized by a system used as a security means for enclosed residential and non-residential premises, open perimeters of warehouses, garages, office and industrial buildings, and video intercoms. In the known method, the system that realizes it provides the use of coaxial interconnection of the master antenna for transmitting TV signal to TV monitors at observation points without creating interference with TV broadcast stations. The system comprises TV monitors, cable distributors, a video and audio monitoring unit, a TV signal synchronization unit, a feeder cable, and a feeder cable amplifier, wherein the video and audio monitoring unit comprises a video camera, a microphone, a video signal converter, an amplifier, a modulator, a controlling filter, and a heterodyne, while the TV signal synchronization unit comprises a frequency-independent attenuator, an amplitude equalizer, and a dithering unit (see Patent RU No. 2149460, published in 2000).

The drawback of the known method is its narrow functionality. The drawback is due to the fact that the known method does not provide simultaneous picture transmission in real time from several video cameras located at considerable distances from one another over a single multichannel system bus to the conversion point and displaying all pictures to the user on one or several monitors in real time.

The closest and used as the prototype is the method for multichannel video monitoring wherein audio monitoring is conducted at the same time as visual monitoring, and when conducting simultaneous visual and audio monitoring using a security system the object's cable TV network is used. The device that realizes the method comprises video cameras, microphones, a modulated radio-frequency TV signal driver unit, a TV signal receiver unit, a wideband video amplifier, and consoles for TV receivers of users of the cable TV network (see Patent RU No. 2153567, published in 2000).

The drawback of the known method for multichannel video monitoring using coaxial interconnection of the master antenna for transmitting one TV signal to consumer TV sets is that it is not intended for bringing the information to a single control room and does not provide simultaneous reception of a video signal from several video cameras spread over a large territory with the capability to viewing and presenting them to the user together on the same monitor, or, if the operator so chooses, viewing and presenting in real time the video situation of selected objects with additional information.

The technical result achieved by using the inventions is broadening the functionality by providing picture transmission in real time from several video cameras spread at different distances over a single multichannel system bus to the conversion point with subsequently displaying them, including additional information, on one or several monitors.

There is the following cause-and-effect relationship between the distinctive features and the technical result achieved.

The placement of video monitoring units (video cameras) at traffic interchanges and subsequent transmission of information received in real time from video monitoring units (video cameras) to the central console for receiving, logging, recording and processing of received information where information from the video cameras is processed and fed to a broadcasting studio equipment room, where, using a set of equipment, circuits and methods for processing and analysis of the received information, the information is formed using, for instance, multiplexing and/or squaring and is presented on a screen to the end user, makes it possible for the user to quickly and effectively make a decision selecting the shortest route to his workplace or to the place where a critical situation has occurred. The use of any known system for presenting processed information to the end user, for instance, of cable TV channels by means of which pictures received from video cameras placed at traffic interchanges are filled in real time, ensures quick feeding of information and high effectiveness of the claimed method as opposed to analogues and the prototype. Filling a monitor screen, continuously or using long-duration switching, with information received in real time from video monitoring units (video cameras), as well as the supplementation with a subtitle denoting the location of the information source of each window for displaying such information on a monitor and/or with a mark on the site plan also improves the effectiveness because it ensures quick acquisition of information from a certain place (bridge, intersection, street, etc.). Complete filling of the end user's screen with a picture from said sources conducted simultaneously with combining it with other information fed by means of television also increases functionality of the claimed method as it provides not only picture transmission in real time from several widely spread video cameras over a single multichannel system bus, but also provides additional information, including information for reception by the end user.

Thus, the combination of the claimed method features makes it possible to improve effectiveness of the claimed method, as opposed to analogues and the prototype, by picture transmission in real time from several video cameras spread at different distances, over a single multichannel system bus to a conversion point, with subsequently feeding them, including additional information, to one or several monitors.

Applicant's analysis of prior art, including the search of patent and science and technology information sources and finding sources containing information on analogues of the claimed invention made it possible to establish that the applicant has not found a source characterized by the features identical to the combination of all essential features of the claimed method for multichannel video monitoring of traffic interchanges.

According to applicant's information, the combination of the essential features of the claimed invention, “The method for multichannel video monitoring of traffic interchanges”, is not known from prior art, which makes it possible to conclude that the invention meets the criterion of “novelty”. Determining, among the found analogues, the prototype as the closest analogue in terms of the combination of features has made it possible to identify the combination of distinctive features that are essential with respect to the technical result perceived by the applicant in the claimed method for multichannel video monitoring of traffic interchanges, said distinctive features are set out in the claims. Therefore, the claimed invention, “The method for multichannel video monitoring of traffic interchanges”, meets the criterion of “novelty”.

To check if the claimed invention meets the criterion of “inventive level”, the applicant performed additional search of known solutions in order to identify features matching the features distinct from the prototype of the claimed method for multichannel video monitoring of traffic interchanges. The search results have demonstrated that for a person skilled in the art the claimed method for multichannel video monitoring of traffic interchanges does not follow from prior art because no effect of transformations provided by essential features of the claimed invention in order to achieve the technical result has been identified by the applicant in prior art.

Therefore, the claimed invention, “The method for multichannel video monitoring of traffic interchanges”, meets the criterion of “inventive level”.

Thus, the above information demonstrates the fulfillment of the combination of conditions in the form the claimed method is characterized in the claims when using the claimed method for multichannel video monitoring of traffic interchanges, i.e., the possibility of realizing the method using the technical means in the examples described in the application is confirmed. The means that embody the claimed method for multichannel video monitoring of traffic interchanges as it is implemented make it possible to ensure achieving the technical result perceived by the applicant, namely, to improve the effectiveness and broaden the functionality by providing picture transmission in real time from several video cameras spread at different distances, over a single multichannel system bus to the conversion point with subsequently displaying them, including additional information, on one or several monitors; therefore, the claimed invention, “The method for multichannel video monitoring of traffic interchanges”, meets the criterion of “industrial applicability”.

The combination of essential features that characterize the essence of the invention, “The method for multichannel video monitoring of traffic interchanges”, can be reused in not too technologically complicated video monitoring of traffic interchanges, with achieving the technical result of improved effectiveness.

### SUMMARY

According to the invention, in the known method for multichannel video monitoring comprising monitoring of the state of objects using video monitoring units, the video monitoring units (video cameras) are placed at traffic interchanges, and the information received from the video monitoring units (video cameras) is transmitted over an information transmission system to a broadcasting studio equipment room where, using a set of equipment, circuits and methods for processing and analysis of information received from the central receiving, recording and processing console, the received information is formed using, for instance, multiplexing and/or squaring and is presented on a screen to the end user, wherein any known system for presenting processed information to the end user is used, for instance, cable TV channels by means of which the filling with pictures received from video cameras placed at traffic interchanges is performed in real time, wherein the end user's monitor screen is filled, continuously or using long-duration switching, with information received in real time from video monitoring units, and each window for displaying such information on a monitor is supplemented with a subtitle denoting the location of the information source and/or with a mark on the site plan, complete filling of the end user's screen with the picture from said sources is done simultaneously with combining other information fed by means of television, and the final picture for the user is formed and fed using a specified TV, Internet channel to a signal distribution network, to be received by the end user.

### DRAWINGS

The essence of the claimed invention, “The method for multichannel video monitoring of traffic interchanges”, is explained in examples of its embodiment and in the schematic diagram where:

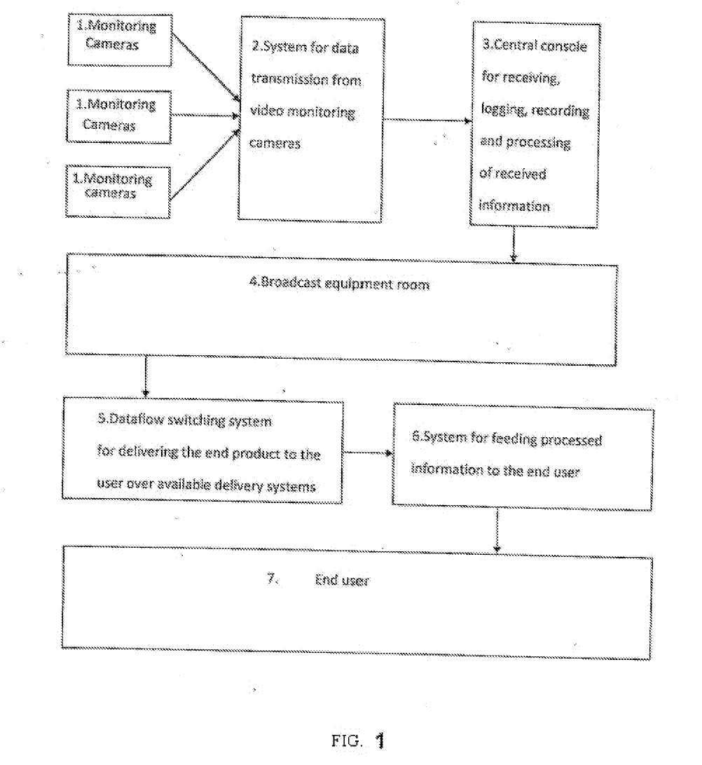

FIG. 1 shows the schematic diagram of realization of the method; and
1. Monitoring cameras
2. System for data transmission from video monitoring cameras
3. Central console for receiving, logging, recording and processing of received information
4. Broadcast equipment room
5. Dataflow switching system for delivering the end product to the user over available delivery systems
6. System for feeding processed information to the end user
7. End user

### DESCRIPTION

The method for multichannel video monitoring of traffic interchanges was realized as follows.

Several outdoor information acquisition sources were placed in monitoring zones at traffic interchanges; the sources were video monitoring units, each having one video camera for outdoor monitoring. The video monitoring units with outdoor monitoring cameras were placed at the city of Tyumen largest traffic interchanges, namely, the Tura river bridges at Chelyuskintsev, Melnikaite and Profsoyuznaya Streets and overpass bridges at Maurice Thorez, Permyakov and Melnikaite Streets. The information received from the monitoring units (video cameras) over a data transmission system was processed and transmitted over a fiber optic cable, coaxial, radio frequency, Internet and local networks to a single monitoring center to the central console for receiving, logging, recording and processing of received information where information from the video cameras was fed to a broadcasting studio equipment room using video recorders, switches, integrators and picture and sound synthesizers; in the broadcasting studio equipment room, using a set of equipment, circuits and methods for processing and analysis of information received from the central console for receiving, recording and processing of received information, a screen for the end user is formed using, for instance, multiplexing etc. to give the end user the capability to perform his own visual assessment of traffic load at traffic interchanges in real time in various areas of the city, with possible additional information. Thus, in the broadcasting studio equipment room the received signal was fed for screen forming to a dataflow switching system comprising devices for signal switching, generation, amplification, synchronization, compression and conversion, for transmission over available networks, to deliver the end product to the user. Here, a system for feeding processed information to the end user was used, namely, networks and systems of digital, broadcast, Internet, cable TV channels etc., that were used for filling in real time end user's monitor screens with pictures received from outdoor monitoring cameras placed at said traffic interchanges, i.e., with information received from one or several video monitoring units. The end user's screen was filled with pictures from said sources, at the same time combining the pictures with other information fed by means of television. The end picture for the user was formed and fed over a specified TV, Internet channel to a signal distribution network for reception by the end user. In a real time mode the end user's monitor screen was filled, using continuous or long-duration switching, with information received from video monitoring units. Each window for displaying such information on a monitor was supplemented with a subtitle denoting the location of the information source and/or with a mark on the site plan. In a force-majeure circumstances mode or a heightened security mode the video picture from the information source was replaced with a schematic layout of the monitored area and a symbolic notation of vehicle traffic load of the area was included. The proposed “Method for multichannel video monitoring of traffic interchanges” made it possible for the end user to independently assess in real time the situation on roads and make a decision on the algorithm of his further actions—whether to walk or to use transportation; it also made it possible to receive at the same time other additional (commercial, promotional, news, subject) information placed on the screen at the same time in the form of lines of printed information, windows with TV broadcasting (of programs, broadcasts, movies and video films, commercial and social video clips, printed advertisement, etc.), combined on the screen with the picture received in real time from outdoor monitoring cameras placed in monitored areas.

A computer with a software-hardware multiplexor with the capability of synchronization of the audio channel and digital recording was used as the control console, and the control console was sequentially connected to each cable transmitter; a unit for adding ranges (adder) of video and audio signals from cable transmitters that is built in into a TV cable bus formed by a coaxial cable was introduced into the system; the input of each cable transmitter was connected to the output of the respective video camera and microphone, and the cable transmitter output was connected to the input of the range addition unit. The power injector—a power supply unit with a filter—is intended for supplying power to system components, namely, to cable transmitters and video cameras with microphones, wherein the unit for power supply through the filter which ensures non-transmission of TV signals to the power supply unit and non-attenuation of signals was connected to the coaxial cable. A personal computer with an expansion card that makes it possible to simultaneously receive and display several monitoring objects on the screen (software-hardware multiplexor) with the capability of synchronization of the audio channel and digital recording was used as the control unit. The range adding unit (adder) equipped additionally with a one-input level control for equalizing the levels of the input signals and the summated signal additionally comprises a power passage circuit which provided passage of a several-amperes current over the center conductor of a coaxial cable without introducing interference with the operation of the range adding unit (adder); in doing this, the problem of developing a compact device that does not complicate the system by the presence of additional components was solved.

The cable transmitter intended for conversion of video and audio signals to a radio frequency signal ensures:
the absence of mismatch of the bus wave resistance, and as a result the absence of cross-talk interference, re-reflections, attenuations and beats of other bus signals;
the absence of interference at higher-frequency bus TV signals;
the capability of equalizing the level with the TV signals baseband, and as a result normal operation of downstream bus equipment (bus TV amplifiers, equalizers, dividers, couplers, etc.);
supplying power to itself, the video camera, etc. from arbitrary bus supply voltage. There is no need for labor-intensive calculation of voltage drop across different cable types and different bus lengths;
normal passage of feedback control signals (subcarrier frequencies) in the bus, i.e., signals from the customer to the sources.

The claimed invention, “The method for multichannel video monitoring of traffic interchanges”, makes it possible to broaden the functionality by providing picture transmission in real time from several video cameras over a single multichannel system bus to the conversion point with subsequent displaying on one or more monitors, improve the effectiveness, and as a result improve the quality of life and reduce the number of traffic accidents.

What is claimed is:

1. A solid state cup device that assists a coil over arrangement of an air suspension system for at least one motor vehicle wheel, the device comprising: at least one outer cup having a plurality of o-rings placed on the coil over arrangement; and at least one inner cup having a plurality of smaller o-rings, said at least one inner cup placed on top of at least one spring; whereby with air injected into the at least one outer cup, the at least one inner cup may press down the at least one spring to provide tension on the at least one spring resulting in a smoother lift and lowering of the at least one motor vehicle wheel.

2. The solid state cup device of claim 1, wherein the at least one outer cup includes at least one o-ring to prevent the at least one inner cup from sliding out of the at least one outer cup.

3. The solid state cup device of claim 1, wherein the at least one outer cup may be adapted for receiving at least one air injecting means.

4. The solid state cup device of claim 1, wherein the plurality of o-rings are arranged in an inner diameter of the at least one outer cup for providing protection from an air leak.

5. The solid state cup device of claim 1, wherein the at least one coil over arrangement is a strut-spring arrangement.

6. The solid state cup device of claim 1, wherein the at least one solid state cup device is made from aluminum, titanium, iron, steel, or wood.

7. The solid state cup device of claim 1, wherein the at least one cup device may be made from an aluminum alloy.

8. The solid state cup device of claim 7, wherein the aluminum alloy is a 6061 aluminum material.

9. The solid state cup device of claim 1, wherein the at least one solid state cup device is air leak protected by way of a dual-quad air leak protection mechanism.

10. The solid state cup device of claim 1, wherein the cup device is adapted to move from a raised position to a lowered position, and vice versa.

11. A method of using a solid state cup device to assists a coil-over arrangement of an air suspension system of a motor vehicle, the method comprises: Activating at least one switch 160 to move air from an air compressor into the direction of the solid state cup, the air first entering an inlet to a reserve tank and then existing the reserve tank, then entering the solid state cup through an opening which then forces an inner cup of the solid state cup in a downward direction, thereby raising suspension of the motor vehicle; and deactivating the at least one switch so that air is released from the solid state cup, thereby allowing the inner cup to rise and lower suspension of the motor vehicle.

12. A method of installing a solid state cup device to a motor vehicle, comprising the steps of: Removing the original OEM coil over suspension; Assemble the solid state cup device to the OEM coil over suspension and reinstalling the OEM coil over suspension; and Installing ¼ tubing lines to the solid state cup and routing the tubing lines through the inside of the motor vehicle to a valve command switch, air compressor, and air reserve tank, wherein the air compressor and air reserve tank are installed in the trunk of the motor vehicle.
